(19) United States
(12) Patent Application Publication
(10) Pub. No.: US 2025/0358351 A1
(43) Pub. Date: Nov. 20, 2025

(54) METHODS, DEVICES, AND SYSTEMS FOR DELIVERING SERVICE CHARACTERISTICS INFORMATION

(71) Applicant: ZTE Corporation, Shenzhen (CN)

(72) Inventors: Yingjun ZHOU, Shenzhen (CN); Zhuang Liu, Shenzhen (CN); Xiubin Sha, Shenzhen (CN); Dapeng Li, Shenzhen (CN); Yin Gao, Shenzhen (CN)

(73) Assignee: ZTE Corporation, Shenzhen (CN)

(21) Appl. No.: 19/290,607

(22) Filed: Aug. 5, 2025

Related U.S. Application Data
(63) Continuation of application No. PCT/CN2023/095309, filed on May 19, 2023.

(51) Int. Cl. H04L 69/322; H04L 5/00

(52) U.S. Cl. CPC H04L 69/322; H04L 5/0044

(57) ABSTRACT

The present disclosure describes methods, system, and devices for delivering service characteristics information. One method includes sending, by a first network node, downlink (DL) data to a second network node, the DL data comprising service characteristic information corresponding to a data burst comprising at least one protocol data unit (PDU) set. Another method includes receiving, by a second network node, DL data from a first network node, the DL data comprising service characteristic information corresponding to a data burst comprising at least one PDU set.

### TECHNICAL FIELD

The present disclosure is directed generally to wireless communications. Particularly, the present disclosure relates to methods, devices, and systems for delivering service characteristics information.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Some devices and applications require high date rate and low latency, for example, applications including Extended Reality (XR), Virtual Reality (VR), Mixed Reality (MR), video streaming, etc. Efficient and robust congestion control and mitigation mechanism is critical for supporting these applications. Identification and awareness of data packets that are dropped may be utilized by a receiving entity, so the receiving entity may be aware of these data packets dropped as early as possible. For these kinds of service requires high data rate and low latency, the service characteristics information is used to optimize gNB radio resource scheduling, e.g. improving scheduling efficiency. When the scheduling is improved, the data rate and latency can be ensured. There are many issues/problems associated with delivering service characteristics information among wireless communication nodes and/or between wireless communication nodes and wireless communication devices. The issues/problems may include and result in long latency, more signalling overhead, and/or long interruption time.

The present disclosure describes various embodiments for delivering service characteristics information, addressing at least one of the issues/problems discussed above. Various embodiments in the present disclosure may achieve low latency, low overhead, and short interruption time, thus, improving the efficiency and/or performance of the wireless communication.

### SUMMARY

This document relates to methods, systems, and devices for wireless communication, and more specifically, for delivering service characteristics information. Various embodiments in the present disclosure may increase the resource utilization efficiency, boost latency performance of the wireless communication, and/or conserve energy consumption of user equipment.

In one embodiment, the present disclosure describes a method for wireless communication. The method includes sending, by a first network node, downlink (DL) data to a second network node, the DL data comprising service characteristic information corresponding to a data burst comprising at least one protocol data unit (PDU) set.

In another embodiment, the present disclosure describes a method for wireless communication. The method includes receiving, by a second network node, downlink (DL) data from a first network node, the DL data comprising service characteristic information corresponding to a data burst comprising at least one protocol data unit (PDU) set.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may include a non-transitory computer-readable medium.

The above and other aspects and their implementations are described in greater detail in the drawings, the descriptions, and the claims.

### BRIEF DESCRIPTION OF THE DRAWINGS

FIG. 1A shows a schematic diagram of a wireless communication system.

FIG. 1B shows a schematic diagram of a base station.

FIG. 1C shows another schematic diagram of a base station.

FIG. 1D shows a schematic diagram of communications between two network nodes.

FIG. 1E shows a schematic diagram of application data unit structure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a flow diagram of an exemplary embodiment for wireless communication.

FIG. 6 shows a flow diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for delivering service characteristics information.

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Some devices and applications require high date rate and low latency, for example, applications including Extended Reality (XR), Virtual Reality (VR), Mixed Reality (MR), video streaming, etc. Efficient and robust congestion control and mitigation mechanism is critical for supporting these applications. Identification and awareness of data packets that are dropped may be utilized by a receiving entity, so the receiving entity may be aware of these data packets dropped as early as possible. For these kinds of service requires high data rate and low latency, the service characteristics information is used to optimize gNB radio resource scheduling, e.g. improving scheduling efficiency. When the scheduling is improved, the data rate and latency can be ensured. There are many issues/problems associated with delivering service characteristics information among wireless communication nodes and/or between wireless communication nodes and wireless communication devices. The issues/problems may include and result in long latency, more signalling overhead, and/or long interruption time.

In various embodiments, methods may include service characteristics information in downlink (DL) user data, e.g. DL USER DATA frame. Service characteristics information may include a portion or all of the following: one or more PDU set sequence number (SN), one or more PDU set size in bytes, one or more PDU SN within a PDU Set, one or more indication of end PDU of the PDU set, one or more PDU set importance (PSI), and/or one or more end of data burst indication in the header of the last PDU of the data burst.

In various embodiments, methods may include indicating one or more discarded NR PDCP PDUs in the user data, e.g. DL DATA DELIVERY STATUS frame. The discard indication information may include a portion or all of the following: one or more DL discarded NR PDCP PDU SN flag, one or more DL discarded block information flag, one or more DL discarded NR PDCP PDU SN, one or more DL discarded number of blocks, one or more discarded NR PDCP PDU SN start, and/or one or more discarded block size indicates the number of NR PDCP PDUs counted from the starting SN to be discarded.

In various embodiments, methods may include indicating one or more discarded NR PDCP PDUs in the user data, e.g. DL DATA DELIVERY STATUS frame. The discard indication information may include a portion or all of the following: one or more DL discarded NR PDCP PDU set SN flag, one or more DL discarded PDU set block information flag, one or more DL discarded NR PDCP PDU set SN, one or more DL discarded number of PDU set blocks, one or more discarded NR PDCP PDU set SN start, and/or one or more discarded PDU set block size indicates the number of NR PDCP PDU sets counted from the starting SN to be discarded.

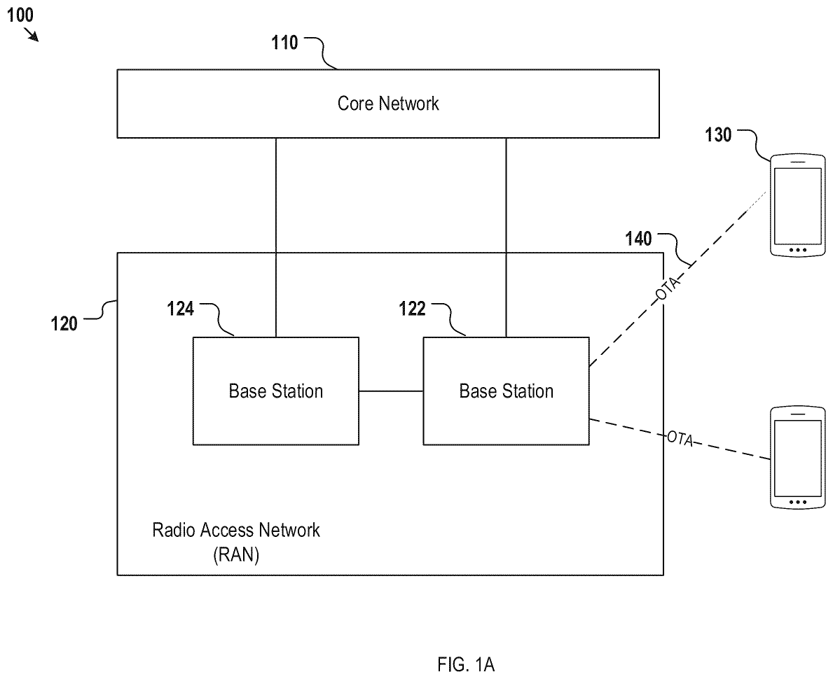

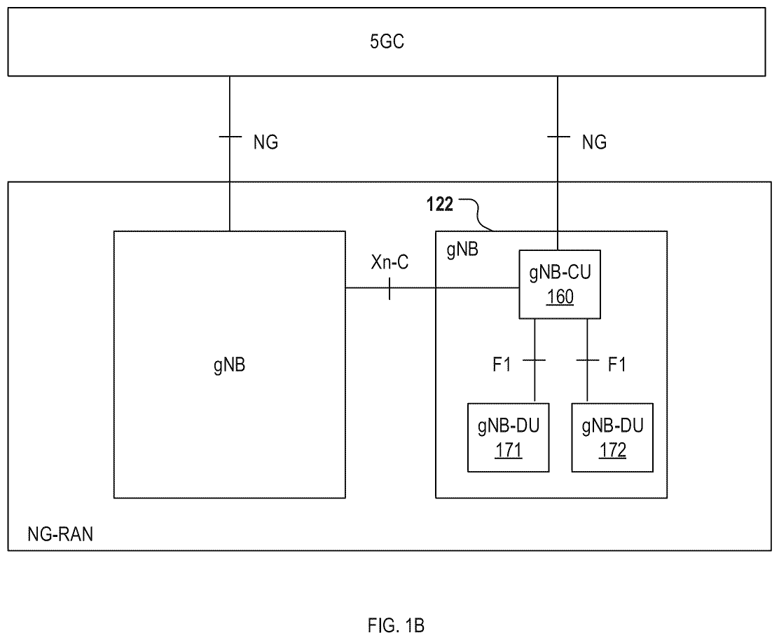

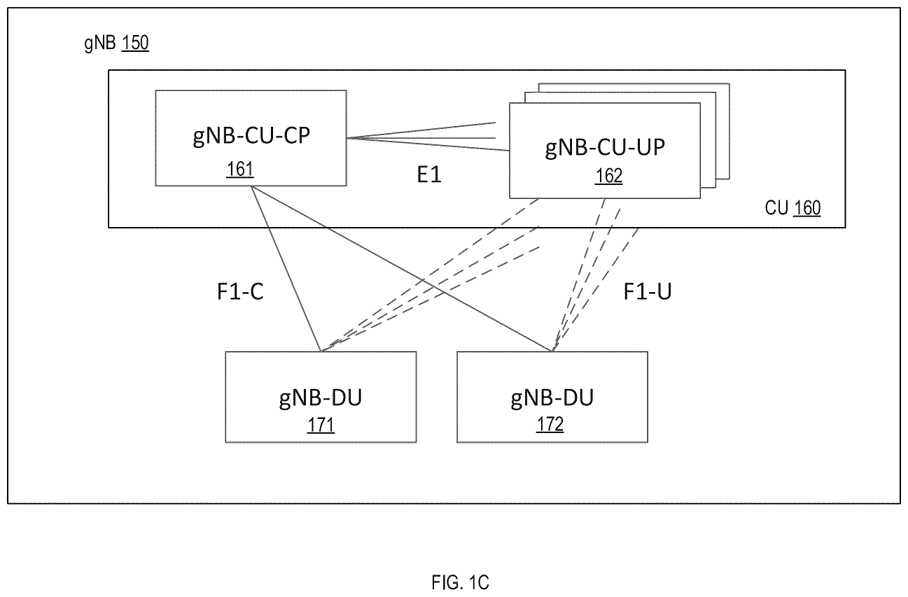

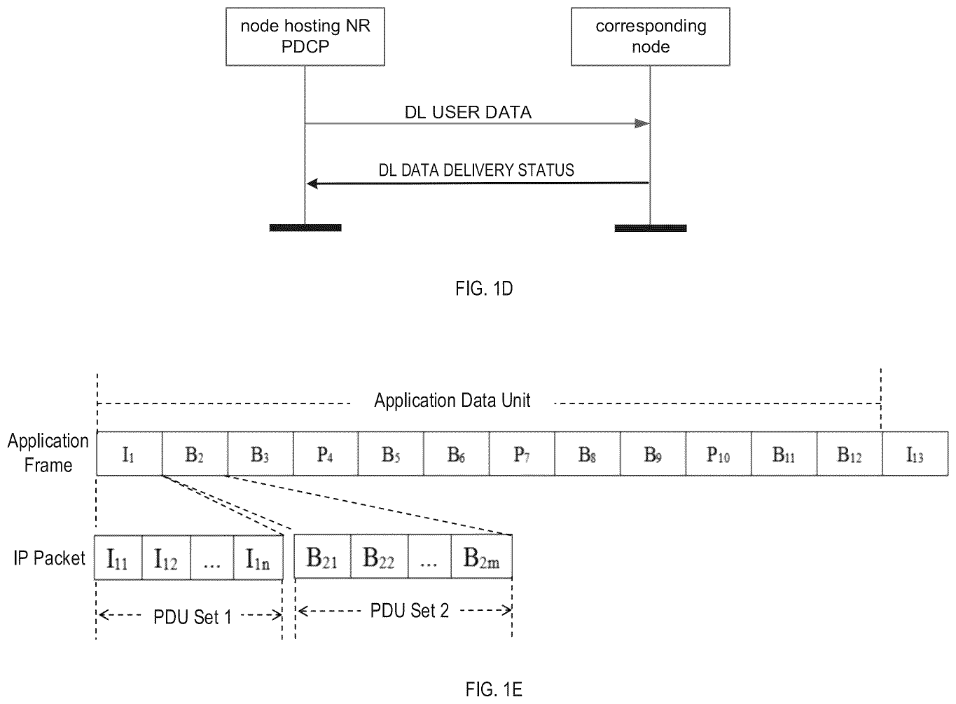

FIG. 1A shows an example cellular wireless communication network 100 (also referred to as wireless communication system) that includes a core network 110, a radio access network (RAN) 120, and one or more user equipment (UE) 130.

The RAN 120 further includes multiple base stations 122 and 124. The base station 122 and one or more user equipment (UE) 130 communicate with one another via over the air (OTA) radio communication resources 140. The wireless communication network 100 may be implemented as, for example, a 2G, 3G, 4G/LTE, 5G, or 6G cellular communication network. Correspondingly, the base stations 122 and 124 may be implemented as a 2G base station, a 3G nodeB, an LTE eNB, or a 5G New Radio (NR) gNB. The UE 130 may be implemented as mobile or fixed communication devices for accessing the wireless communication network 100. The one or more UE 130 may include but is not limited to mobile phones, internet of things (IOT) devices, machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1A, the one or more UE 130 may connect with and establish a communication session with the base station 122 via the OTA interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122. Under certain circumstances, for example when the base station 122 is unavailable or when the UE 130 moves into a coverage of the base station 124, the one or more UE 130 may connect with and establish a communication session with the base station 122.

Referring to FIG. 1B, a base station (e.g., gNB) 122 may have a control-distributed separated structure, which may include a control unit (CU) 160 and one or more distributed unit (DU) 171 and/or 172. The 5GC may communicate with the gNB via a NG interface between them. The gNB and another gNB may communicate via a Xn-C interface. The gNB-CU may communicate with the one or more gNB-DU via a F1 interface.

In some implementations, in the architecture of CU/DU split, a gNB may consist of a gNB Central Unit (gNB-CU) and one or more gNB Distributed Unit (gNB-DU). A gNB-CU and a gNB-DU is connected via F1 interface. The gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell is supported by only one gNB-DU.

In some implementations, the gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell may be supported by only one gNB-DU.

FIG. 1C shows another schematic diagram of a base station (e.g., gNB) 150. The gNB may have a control-distributed separated structure, which may include a control unit (CU) 160 and one or more distributed unit (DU) (for example 171 and/or 172). The CU may include a control plan (gNB-CU-CP) 161 and one or more user plan (gNB-CU-UP) 162. The gNB-CU-CP 161 may be referred as CU-CP or CP, and the gNB-CU-UP 162 may be referred as CU-UP or UP. The CU-CP 161 may communicate with the one or more CU-UP 162 via an E1 interface between them. The CU-CP 161 may communicate with the one or more DU via a F1-C interface, and each of the one or more CU-UP 162 may communicate with the one or more DU via a F1-U interface.

In some implementations, a gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP

In some implementations, for resiliency, a gNB-DU and/or a gNB-CU-UP may be connected to multiple gNB-CU-CPs by appropriate implementation. In some implementations, one gNB-DU can be connected to multiple gNB-CU-UPs under the control of the same gNB-CU-CP. In some implementations, one gNB-CU-UP can be connected to multiple DUs under the control of the same gNB-CU-CP.

In some implementations, the connectivity between a gNB-CU-UP and a gNB-DU is established by the gNB-CU-CP using bearer context management functions.

In some implementations, the gNB-CU-CP selects the appropriate gNB-CU-UP(s) for the requested services for the UE. In some implementations, multiple CU-UPs may belong to same security domain.

In some implementations, data forwarding between gNB-CU-UPs during intra-gNB-CU-CP handover within a gNB may be supported by Xn-U.

In some implementations, a downlink user data may be transferred under certain circumstances. One purpose of the transfer of downlink user data procedure is to provide NR-U specific sequence number information at the transfer of user data carrying a DL NR PDCP PDU from the node hosting the NR PDCP entity to the corresponding node. FIG. 1D shows a schematic diagram of communication between two network nodes, illustrating a transfer of downlink user data and downlink data delivery status, wherein the DL user data is sent by a node hosting NR PDCP and is received by a corresponding node.

In some implementations, a frame format is defined e.g. to allow the corresponding node to detect lost NR-U packets and may be associated with the transfer of a downlink PDCP PDU. Table 1 shows an example for the respective DL USER DATA frame.

TABLE 1
exemplary DL USER DATA frame format

| | | | | | | | | Number |
|---|---|---|---|---|---|---|---|---|
| Bits | | | | | | | | of |
| 7 | 6 | 5 | 4 | 3 | 2 | 1 | 0 | Octets |

| PDU Type (=0) | | Spare | DL | DL | Report | 1 |
|---|---|---|---|---|---|---|
| | | | Discard | Flush | polling | |
| | | | Blocks | | | |
| Spare | Request | Report | User | Assistance | Retransmission | 1 |
| | OutofSeq | Delivered | data | Info. | flag | |
| | Report | | existence | Report | | |
| | | | flag | Polling | | |
| | | | | Flag | | |

| | |
|---|---|
| NR-U Sequence Number | 3 |
| DL discard NR PDCP PDU SN | 0 or 3 |
| DL discard Number of blocks | 0 or 1 |
| DL discard NR PDCP PDU SN start (first block) | 0 or 3 |
| Discarded Block size (first block) | 0 or 1 |
| . . . | |
| DL discard NR PDCP PDU SN start (last block) | 0 or 3 |
| Discarded Block size (last block) | 0 or 1 |
| DL report NR PDCP PDU SN | 0 or 3 |
| Padding | 0-3 |

In some implementations, a downlink data delivery status may be transferred. One purpose of the downlink data delivery status procedure is to provide feedback from the corresponding node to the node hosting the NR PDCP entity to allow the node hosting the NR PDCP entity to control the downlink user data flow via the corresponding node for the respective data radio bearer. The corresponding node may also transfer uplink user data for the concerned data radio bearer to the node hosting the NR PDCP entity together with a DL DATA DELIVERY STATUS frame within the same GTP-U PDU. Table 2 shows an example for the respective DL DATA DELIVERY STATUS frame, serving as an example of how a frame is structured when all optional information elements (IEs) (i.e. those whose presence is indicated by an associated flag) are present.

TABLE 2
DL DATA DELIVERY STATUS frame format

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=1) | | | | Highest | Highest | Final | Lost | 1 |
| | | | | Transmitted | Delivered | Frame | Packet | |
| | | | | NR | NR | Ind. | Report | |
| | | | | PDCP | PDCP | | | |
| | | | | SN Ind | SN Ind | | | |
| Spare | | | Delivered | Data | Retransmitted | Delivered | Cause | 1 |
| | | | NR | rate | NR | Retransmitted | Report | |
| | | | PDCP | Ind. | PDCP | NR | | |
| | | | SN | | SN Ind | PDCP | | |
| | | | Range | | | SN Ind | | |
| | | | Ind | | | | | |

| | |
|---|---|
| Desired buffer size for the data radio bearer | 4 |
| Desired Data Rate | 0 or 4 |
| Number of lost NR-U Sequence Number ranges reported | 0 or 1 |
| Start of lost NR-U Sequence Number range | 0 or (6* |
| End of lost NR-U Sequence Number range | Number of |
| | reported lost |
| | NR-U SN |
| | ranges) |
| Highest successfully delivered NR PDCP Sequence Number | 0 or 3 |
| Highest transmitted NR PDCP Sequence Number | 0 or 3 |
| Cause Value | 0 or 1 |
| Successfully delivered retransmitted NR PDCP Sequence Number | 0 or 3 |
| Retransmitted NR PDCP Sequence Number | 0 or 3 |
| Number of successfully delivered out of sequence PDCP Sequence | 0 or 1 |
| Number range | |
| Start of successfully delivered out of sequence PDCP Sequence | 0 or (6* |
| Number range | Number of |
| End of successfully delivered out of sequence PDCP Sequence Number | successfully |
| range | delivered out |
| | of sequence |
| | PDCP |
| | Sequence |
| | Number range) |
| Padding | 0-3 |

In various embodiments/implementations in the present disclosure, a XR service may include video streaming, which is expressed by multiple application data units, and each application data unit is composed by multiple application frames (e.g. I-frame, P-frame, B-frame). Referring to FIG. 1E, one application frame may include at least one IP packets, which can be expressed in a PDU set (e.g. a sequence of packets that includes, e.g., all the necessary information to reconstruct a video frame, equivalent to the “media unit” or a “slice”, video/audio frame/tile, haptic application information) in QoS flow, e.g. GTP-U, NG user plane interface (NG-U), Xn User plane (Xn-U) interface, or user data from non-access stratum (NAS). For example, one of the application frames (I₁) may include a first PDU Set (PDU Set 1), which includes n PDUs (i.e., I₁₁, I₁₂, I₁₃, . . . . I₁ₙ), wherein n is a positive integer. For another example, another of the application frames (B₂) may include a second PDU Set (PDU Set 2), which includes m PDUs (i.e., B₁₁, B₁₂, B₁₃, . . . . B₁ₘ), wherein m is a positive integer.

In some implementations, an I-frame is a keyframe, which stores/transmits all of the data needed to display that frame. Typically, I-frames are interspersed with P-frames and B-frames in a compressed video. The more I-frames that are contained, the better quality the video will be; however, I-frames contain the most amount of bits and therefore take up more space on the storage medium and consumes more radio resource to deliver it over Uu interface. A P-frame is a delta frame, which contains only the data that have changed from the preceding I-frame (such as color or content changes). Because of this, P-frame depend on the preceding I-frame to fill in most of the data. A B-frame is also a delta frame, which contains only the data that have changed from the preceding frame and are different from the data in the very next frame. Thus, the B-frame depends on the frames preceding and following it to fill in most of the data.

In various embodiments/implementations in the present disclosure, a protocol data unit (PDU) set may be a set including one or more PDUs carrying the payload of one unit of information generated at the application level (e.g. a frame or video slice for XRM services). Data burst may include one or more PDU set generated and sent by the application in a short period of time. Periodicity may be the time duration between the start of two data bursts. Burst arrival time may be the latest possible time when the first packet of the data burst arrives at either the ingress of the RAN (downlink flow direction) or the egress interface of the UE (uplink flow direction). In some implementations all PDUs in a PDU Set are needed by the application layer to use the corresponding unit of information. In other implementations, the application layer can still recover parts all or of the information unit, when some PDUs are missing.

In various embodiments/implementations in the present disclosure, a PDU may refer to a NR-U PDU or PDCP PDU contained in NR-U PDU. In some implementations, a core network may send NG-U PDU (also GTP-U PDU) to the base station. The data packets inside are IP packets. A protocol may modify the GTP-U extension header, the base station (e.g., CU) may extract the data packet after getting the PDU of the core network, encapsulate it into a PDCP PDU, and add a GTP-U extension header to it (encapsulated into a GTP-U PDU, also NR-U PDU), plus PDCP header to a DU. In various implementations, a NR PDCP PDU may refer as a PDCP PDU; and/or a PDCP PDU may include a NR PDCP PDU.

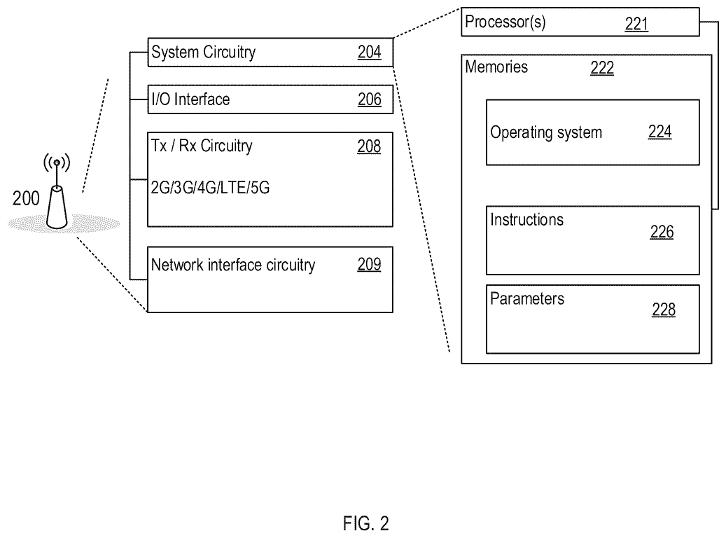

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

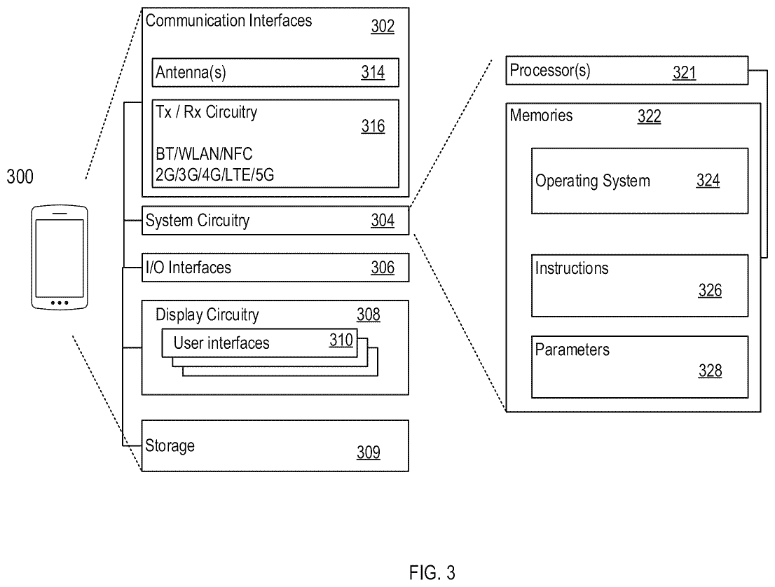

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for delivering service characteristics information, which may be implemented, partly or totally, on the network base station and/or the user equipment described above in FIGS. 2-3.

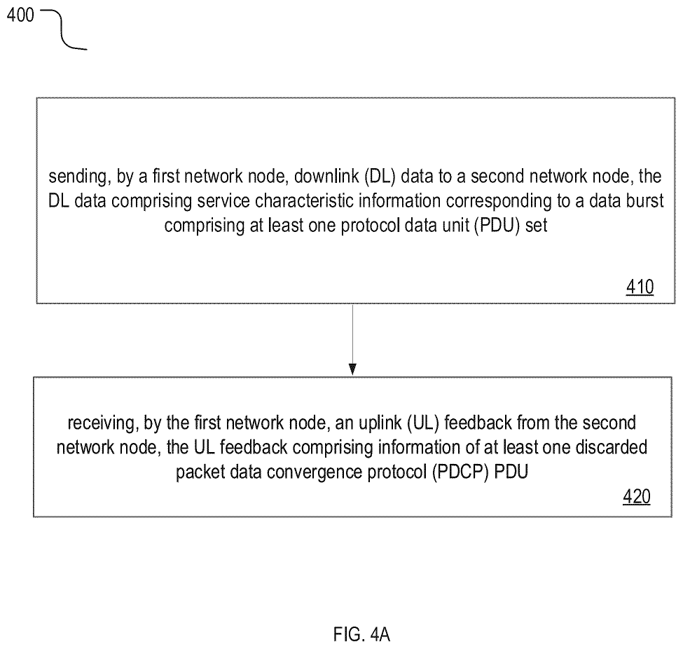

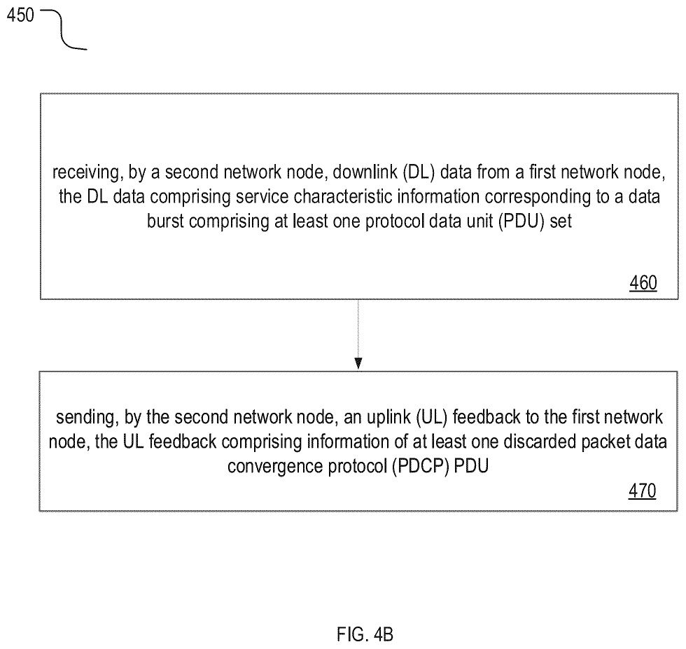

Referring to FIG. 4A, the present disclosure describes various embodiments of a method 400 for wireless communication. The method 400 may include step 410, sending, by a first network node, downlink (DL) data to a second network node, the DL data comprising service characteristic information corresponding to a data burst comprising at least one protocol data unit (PDU) set.

In some implementations, the method 400 may further include step 420, receiving, by the first network node, an uplink (UL) feedback from the second network node, the UL feedback comprising information of at least one discarded packet data convergence protocol (PDCP) PDU.

Referring to FIG. 4B, the present disclosure describes various embodiments of a method 450 for wireless communication. The method 450 may step 460, receiving, by a second network node, downlink (DL) data from a first network node, the DL data comprising service characteristic information corresponding to a data burst comprising at least one protocol data unit (PDU) set.

In some implementations, the method 450 may further include step 470, sending, by the second network node, an uplink (UL) feedback to the first network node, the UL feedback comprising information of at least one discarded packet data convergence protocol (PDCP) PDU.

In some implementations, the first network node and the second network node respectively comprise one of the following: a first radio access network (RAN) node and a second RAN node, or a central unit (CU) of a RAN node and a distributed unit (DU) of the RAN node; the DL data comprises a user plane frame; and the UL feedback comprises a user plane frame.

In some implementations, the DL data comprises a DL user data frame; and the UL feedback comprises a DL data delivery status frame.

In some implementations, in response to a network being congested, the at least one discarded PDCP PDU comprises at least one PDCP PDU in a PDU set with low importance; and in response to a PDCP PDU in a PDU set not being successfully delivered to the UE and the PDU set requiring integrated handling, the at least one discarded PDCP PDU comprises all other PDCP PDUs in the PDU set.

In some implementations, network congestion may be described as the congestion between the gNB and UE. In some implementations, network congestion may also be described as the cell is in congestion state, including cell radio congestion, cell hardware congestion, etc.

In some implementations, the DL data comprises a service characteristic information flag indicating whether the DL data comprises the service characteristic information; and/or in response to the service characteristic information flag indicating that the DL data comprises the service characteristic information, the service characteristic information comprises at least one of the following: a PDU set sequence number, a PDU set size, a PDU sequence number within a PDU set, a first indicator indicating to be an end PDU of a PDU Set, a PDU set importance (PSI), a second indicator indicating to be an end PDU of the data burst.

In some implementations, the DL data comprises a service characteristic information flag indicating whether the DL data comprises the service characteristic information; and/or in response to the service characteristic information flag indicating that the DL data comprises the service characteristic information, the service characteristic information comprises a PDU set size and an indicator indicating to be an end PDU of the data burst.

In some implementations, the DL data comprises a service characteristic information flag indicating whether the DL data comprises service characteristic information; and/or in response to the service characteristic information flag indicating that the DL data comprises the service characteristic information, the service characteristic information comprises a PDU set sequence number, a PDU sequence number within a PDU set, an indicator indicating to be an end PDU of a PDU set, and a PDU set importance (PSI).

In some implementations, the DL data comprises a first indicator indicating to be an end PDU of a PDU Set and a second indicator indicating to be an end PDU of the data burst.

In some implementations, the DL data further comprises a first flag for the first indicator and a second flag for the second indicator, wherein the first flag indicates whether the DL data comprises the first indicator and the second flag indicates whether the DL data comprises the second indicator.

In some implementations, the UL feedback comprises a first flag indicating whether the UL feedback comprises a PDU sequence number and a second flag indicating whether the UL feedback comprises PDU block information; in response to the first flag indicating that the UL feedback comprises the PDU sequence number, the UL feedback comprises the PDU sequence number indicating a PDCP PDU range in which a plurality of PDCP PDUs are discarded, wherein the PDCP PDU range is based on the PDU sequence number; and/or in response to the second flag indicating that the UL feedback comprises the PDU block information, the UL feedback comprises the PDU block information indicating one or more PDCP PDU blocks being discarded.

In some implementations, the PDU block information comprises N and N sets of a block start number and a block size, wherein N is a positive integer indicating a number of PDCP PDU blocks that are discarded, the block start number indicates a starting sequence number of a PDCP PDU block that is discarded, and the block size indicates a number of PDCP PDUs that are counted from the starting sequence number being discarded.

In some implementations, the UL feedback comprises a first flag indicating whether the UL feedback comprises a PDU set sequence number and a second flag indicating whether the UL feedback comprises PDU set block information; in response to the first flag indicating that the UL feedback comprises the PDU set sequence number, the UL feedback comprises the PDU set sequence number indicating a PDCP PDU set range in which a plurality of PDCP PDU sets are discarded, wherein the PDCP PDU set range is based on the PDU set sequence number; and/or in response to the second flag indicating that the UL feedback comprises the PDU set block information, the UL feedback comprises the PDU set block information indicating one or more PDCP PDU set blocks being discarded.

In some implementations, the PDU set block information comprises N and N sets of a block start number and a block size, wherein N is a positive integer indicating a number of PDCP PDU set blocks that are discarded, the block start number indicates a starting sequence number of a PDCP PDU set block that is discarded, and the block size indicates a number of PDCP PDU sets that are counted from the starting sequence number being discarded.

The present disclosure describes various embodiments with exemplary examples for delivering service characteristics information. Exemplary embodiments provide examples for the present disclosure, and does not impose any limitation on the present disclosure. In the embodiments and implementation of this disclosure, any steps and/or operations may be combined or arranged in any amount or order, as desired. Two or more of the steps and/or operations may be performed in parallel. Embodiments and implementations in the disclosure may be used separately or combined in any order. Further, any one of the methods (or embodiments), a wireless communication node, and a wireless communication device may be implemented by processing circuitry (e.g., one or more processors or one or more integrated circuits).

### Embodiment Set I

TABLE 3
Service characteristics information existence flag indicating the presence of service
characteristics information

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=0) | | | | Spare | DL | DL | Report | 1 |
| | | | | | Discard | Flush | polling | |
| | | | | | Blocks | | | |
| Spare | | Service | Request | Report | User | Assistance | Retransmission | 1 |
| | | characteristics | OutofSeq | Delivered | data | Info. | flag | |
| | | information | Report | | existence | Report | | |
| | | existence | | | flag | Polling | | |
| | | flag | | | | Flag | | |

| | |
|---|---|
| NR-U Sequence Number | 3 |
| DL discard NR PDCP PDU SN | 0 or 3 |
| DL discard Number of blocks | 0 or 1 |
| DL discard NR PDCP PDU SN start (first block) | 0 or 3 |
| Discarded Block size (first block) | 0 or 1 |
| . . . | |
| DL discard NR PDCP PDU SN start (last block) | 0 or 3 |
| Discarded Block size (last block) | 0 or 1 |
| DL report NR PDCP PDU SN | 0 or 3 |
| Service characteristics information | 0 or N |
| Padding | 0-3 |

Various embodiments in the present disclosure includes service characteristics information existence flag indicating the presence of service characteristics information. In some implementations, its field length may include 1 bit, which is a non-limiting example, and may include other field length values depending on a final design, wherein a value of 1 may be used to indicate that service characteristics information is present, and a value of 0 may be used to indicate that service characteristics information is not present. Table 3 shows a non-limiting example including one or more service characteristics information existence flag.

In some implementations, the service characteristics information may include a portion or all of the following: PDU Set Sequence Number, PDU Set Size in bytes, PDU SN within a PDU Set, Indication of End PDU of the PDU Set, PDU Set Importance (PSI), End of Data Burst indication in the header of the last PDU of the Data Burst.

In some implementations, the PDU Set Sequence Number, PDU Set Size in bytes, PDU SN within a PDU Set, Indication of End PDU of the PDU Set, or PDU Set Importance (PSI) are PDU set information and identification which is to identify whether PDUs are in the same PDU set.

In some implementations, when the network is congested, one or all of the NR PDCP PDU(s) in the same PDU set with low importance may be discarded. Thus the PDU set information and identification can be used to decide the PDUs that needs to be discarded. In some implementations, network congestion may be described as the congestion between the gNB and UE. In some implementations, network congestion may also be described as the cell is in congestion state, including cell radio congestion, cell hardware congestion, etc.

In some implementations, when there is integrated handling requirement for a PDU set, and when one or some of NR PDCP PDU(s) in the PDU set is not successfully delivered to the UE, all the other NR PDCP PDUs belongs to the same PDU set may be discarded. The PDU set information and identification can also be used to decide the NR PDCP PDUs needs to be discarded for this case.

In some implementations, integrated handling requirement means that all PDUs of the PDU set are needed for the usage of PDU set by application layer.

In some implementations, End of Data Burst indication in the header of the last PDU of the Data Burst is used to configure cDRX, Semi-persistent scheduling (SPS) or configured grant (CG), which is decided by implementation, wherein cDRX denotes connected mode Discontinuous Reception (DRX) and there are two types in cDRX, short DRX cycle and long DRX cycle.

In some implementations, PDU Set Sequence Number indicates the PDU set sequence number. In some implementations, its field length may include 1 octets/bytes, which is a non-limiting example, and may include other field length values depending on a final design.

In some implementations, PDU Set Size in bytes indicates the size of the PDU set which is used to verify whether all the PDUs in the PDU set have been received successfully. In some implementations, its field length may include M octets/bytes, wherein M represents a positive integer.

In some implementations, PDU SN within a PDU Set indicates the PDU sequence number. In some implementations, its field length may include 3 octets/bytes, which is a non-limiting example, and may include other field length values depending on a final design.

In some implementations, indication of End PDU of the PDU Set is used to indicate that this is the last PDU of the PDU set. In some implementations, its field length may include 1 bit, which is a non-limiting example, and may include other field length values depending on a final design, wherein a value of 1 may be used to indicate that this is the last PDU of the PDU set; and a value of 0 may be used to indicate that this is not the last PDU of the PDU set. In some implementations, including this indication may indicate that this is the last PDU of the PDU set, not including this indication may indicate that this is not the last PDU of the PDU set.

In some implementations, PDU Set Importance (PSI) is used to identify the relative importance of a PDU Set compared to other PDU Sets within a QoS Flow. RAN may use it for PDU Set level packet discarding in presence of congestion, e.g. discard the PDU sets with lower PSI. All the PDUs in the same PDU set has the same PSI. In some implementations, its field length may include 1 bit, which is a non-limiting example, and may include other field length values depending on a final design, wherein a value of 1 may be used to indicate that this PDU set is important; and a value of 0 may be used to indicate that that this PDU set is not important. In some implementations, including this indication may indicate that the PDU set is important; and not including this indication may indicate that the PDU set is not important. In some implementations, its field may include 4 bits, which is a non-limiting example, and may include other field length values depending on a final design, wherein a value of 0 may be used to indicate that this PDU set is the most important; and a value of 15 may be used to indicate that that this PDU set is the least important.

In some implementations, end of Data Burst indication in the header of the last PDU of the Data Burst is used to indicate that this is the last PDU of the data burst. In some implementations, its field length may include 1 bit, which is a non-limiting example, and may include other field length values depending on a final design, wherein a value of 1 may be used to indicate that this is the last PDU in the data burst; and a value of 0 may be used to indicate that this is not the last PDU in the data burst. In some implementations, including this indication may also indicate that this is the last PDU in the data burst, not including this indication may also indicate this is not the last PDU in the data burst.

For one non-limiting example, referring to FIG. 1E, I1 frame includes I11, I12, . . . , In packets (PDU), which corresponds to PDU set 1. I11 represents that the PDU Set Sequence Number is 1 and the PDU SN within a PDU Set is 1. I12 represents that the PDU Set Sequence Number is 1 and the PDU SN within a PDU Set is 2. Indication of End PDU of the PDU Set is 1 indicating that this PDU is the last PDU of the PDU set. Indication of End PDU of the PDU Set is 0 indicating that this PDU is not the last PDU of the PDU set. Indication of End PDU of the PDU Set in I1n is 1 and in I11, I12, . . . , I1n-1 is 0. In some implementations, Indication of End PDU of the PDU Set in I1n is 1, and there is no indication of End PDU of the PDU Set in I11, I12, . . . , I1n-1.

In some implementations, PSI for I1 can be 1 and for B2 can be 0 which indicates that I1 is more important than B2. Since I11, I12, . . . , I1n has the same level of importance, PSI can be included in I11 or I1n or every PDU (I11, I12, . . . . I1n all have PSI value 1).

In some implementations, PSI for I1 can be 0 and for B2 can be 15 which indicates that I1 is more important than B2. Since I11, I12, . . . , I1n has the same level of importance, PSI can be included in I11 or I1n or every PDU (I11, I12, . . . . I1n all have PSI value 0).

In some implementations, PDU Set Size in bytes of I1 is the sum size of I11, I12, . . . , I1n.

In some implementations, end of Data Burst indication in the header of the last PDU of the Data Burst is 1 indicating that this PDU is the last PDU in the data burst. End of Data Burst indication in the header of the last PDU of the Data Burst is 0 indicating that this PDU is not the last PDU in the data burst. If I1n is that last PDU of the data burst, end of Data Burst indication in I1n is 1 and in 111, 112, . . . , I1n-1 is 0. In some implementations, end of Data Burst indication in I1n is 1, and there is no indication of End PDU in I11, I12, . . . , I1n-1.

### Embodiment Set II

Various embodiments in the present disclosure includes service characteristics information existence flag indicating the presence of service characteristics information. In some implementations, its field length may include 1 bit, which is a non-limiting example, and may include other field length values depending on a final design, wherein a value of 1 may be used to indicate that service characteristics information is present, and a value of 0 may be used to indicate that service characteristics information is not present.

In some implementations, the service characteristics information may include a portion or all of the following: PDU Set Size in bytes, and End of Data Burst indication in the header of the last PDU of the Data Burst.

In some implementations, the service characteristics information may include a portion or all of the following: PDU Set Sequence Number, PDU SN within a PDU Set, Indication of End PDU of the PDU Set, PDU Set Importance (PSI).

In various implementations, PDU Set Sequence Number, PDU Set Size in bytes, PDU SN within a PDU Set, Indication of End PDU of the PDU Set, PDU Set Importance (PSI), End of Data Burst indication in the header of the last PDU of the Data Burst may have similar meanings and may be implemented similarly as any of other embodiments/implementations described in the present disclosure.

### Embodiment Set III

TABLE 4
frame includes indication of End PDU of the PDU Set and indication of End of Data
Burst indication in the header of the last PDU of the Data Burst

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=0) | | | | Spare | DL | DL | Report | 1 |
| | | | | | Discard | Flush | polling | |
| | | | | | Blocks | | | |
| Spare | Indication | End of | Request | Report | User | Assistance | Retransmission | 1 |
| | of | Data | OutofSeq | Delivered | data | Info. | flag | |
| | End | Burst | Report | | existence | Report | | |
| | PDU | indication | | | flag | Polling | | |
| | of the | in the | | | | Flag | | |
| | PDU | header | | | | | | |
| | Set | of the | | | | | | |
| | | last PDU | | | | | | |
| | | of the | | | | | | |
| | | Data Burst | | | | | | |

| | |
|---|---|
| NR-U Sequence Number | 3 |
| DL discard NR PDCP PDU SN | 0 or 3 |
| DL discard Number of blocks | 0 or 1 |
| DL discard NR PDCP PDU SN start (first block) | 0 or 3 |
| Discarded Block size (first block) | 0 or 1 |
| . . . | |
| DL discard NR PDCP PDU SN start (last block) | 0 or 3 |
| Discarded Block size (last block) | 0 or 1 |
| DL report NR PDCP PDU SN | 0 or 3 |
| Padding | 0-3 |

In various embodiments in the present disclosure includes, a frame may include an indication of End PDU of the PDU Set and/or an indication of End of Data Burst indication in the header of the last PDU of the Data Burst in the frame. Table 4 shows a non-limiting example.

In some implementations, the end of Data Burst indication in the header of the last PDU of the Data Burst is 1 indicating that this PDU is the last PDU in the data burst. End of Data Burst indication in the header of the last PDU of the Data Burst is 0 indicating that this PDU is not the last PDU in the data burst. In some implementations, including this indication may also indicate that this is the last PDU in the data burst, not including this indication may also indicate this is not the last PDU in the data burst.

In some implementations, the indication of End PDU of the PDU Set is 1 indicating that this PDU is the last PDU of the PDU set. Indication of End PDU of the PDU Set is O indicating that this PDU is not the last PDU of the PDU set. In some implementations, including this indication may indicate that this is the last PDU of the PDU set, not including this indication may indicate that this is not the last PDU of the PDU set.

In some implementations, the indication of End PDU of the PDU Set could be not included in the frame when it's “0”.

In some implementations, end of Data Burst indication in the header of the last PDU of the Data Burst could be not included in the frame when it's “0”.

In various implementations, Indication of End PDU of the PDU Set, End of Data Burst indication in the header of the last PDU of the Data Burst may have similar meanings and may be implemented similarly as any of other embodiments/implementations described in the present disclosure.

### Embodiment Set IV

TABLE 5
frame includes End PDU of the PDU Set existence flag and End of Data Burst
indication existence flag

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=0) | | | | Spare | DL | DL | Report | 1 |
| | | | | | Discard | Flush | polling | |
| | | | | | Blocks | | | |
| Spare | End of | Indication | Request | Report | User | Assistance | Retransmission | 1 |
| | Data | of End | OutofSeq | Delivered | data | Info. | flag | |
| | Burst | PDU of | Report | | existence | Report | | |
| | indication | the PDU | | | flag | Polling | | |
| | existence | Set | | | | Flag | | |
| | flag | existence | | | | | | |
| | | flag | | | | | | |
| NR-U Sequence Number | | | | | | | | 3 |
| DL discard NR PDCP PDU SN | | | | | | | | 0 or 3 |
| DL discard Number of blocks | | | | | | | | 0 or 1 |
| DL discard NR PDCP PDU SN start (first block) | | | | | | | | 0 or 3 |
| Discarded Block size (first block) | | | | | | | | 0 or 1 |
| . . . | | | | | | | | |
| DL discard NR PDCP PDU SN start (last block) | | | | | | | | 0 or 3 |
| Discarded Block size (last block) | | | | | | | | 0 or 1 |
| DL report NR PDCP PDU SN | | | | | | | | 0 or 3 |
| Spare | | | | | | End of | End | 0-1 |
| | | | | | | Data | PDU of | |
| | | | | | | Burst | the PDU | |
| | | | | | | indication | Set | |

| | |
|---|---|
| Padding | 0-3 |

In various embodiments in the present disclosure includes, a frame may include an includes End PDU of the PDU Set existence flag and End of Data Burst indication existence flag. Table 5 shows a non-limiting example.

In some implementations, the present example may be different from example in the embodiment set III, wherein the previous example uses 1 bit to include End PDU of the PDU Set and 1 bit to include Indication of End of Data Burst indication in the header of the last PDU of the Data Burst, and the present example includes these information in the information element field.

In some implementations, the end of Data Burst indication existence flag and Indication of End PDU of the PDU Set existence flag are included. The end of Data Burst indication existence flag indicates the presence of End of Data Burst indication. In some implementations, its field length may include 1 bit, which is a non-limiting example, and may include other field length values depending on a final design, wherein a value of 1 may be used to indicate that End of Data Burst indication is present, and a value of 0 may be used to indicate that End of Data Burst indication is not present. The indication of End PDU of the PDU Set existence flag indicates the presence of Indication of End PDU of the PDU Set. In some implementations, its field length may include 1 bit, which is a non-limiting example, and may include other field length values depending on a final design, wherein a value of 1 may be used to indicate that Indication of End PDU of the PDU Set is present, and a value of 0 may be used to indicate that Indication of End PDU of the PDU Set is not present.

In various implementations, PDU Set Sequence Number, PDU Set Size in bytes, PDU SN within a PDU Set, Indication of End PDU of the PDU Set, PDU Set Importance (PSI), End of Data Burst indication in the header of the last PDU of the Data Burst may have similar meanings and may be implemented similarly as any of other embodiments/implementations described in the present disclosure.

### Embodiment Set V

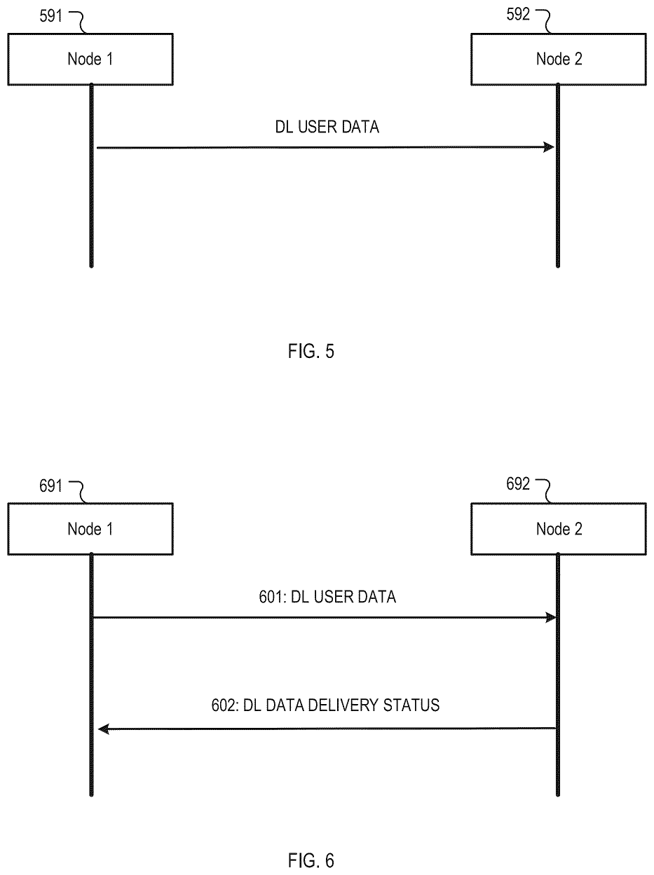

Various embodiments in the present disclosure describe DL USER DATA being transmitted from one network node to another network node. FIG. 5 shows a non-limiting example between a first node (node 1) 591 and a second node (node 2) 592.

In some implementations, when the node 1 sends downlink data to the node 2, the downlink data may be a user plane frame, and/or the downlink data may be a user plane frame, for example, the downlink data may be DL USER DATA frame. The DL USER DATA frame format can use the format as describes in any one or any combination of the embodiments in the present disclosure.

In some implementations, the node 1 may be a gNB1, and node 2 may be a gNB2. In some implementations, the node 1 may be a CU, and the node 2 may be a DU.

### Embodiment Set VI

Various embodiments in the present disclosure describe DL USER DATA being transmitted from one network node to another network node. FIG. 6 shows a non-limiting example between a first node (node 1) 691 and a second node (node 2) 692.

For step 601: The node 1 sends the DL USER DATA to the node 2 which includes the service characteristics information existence flag and service characteristics information. Service characteristics information may include a portion or all of the following: PDU Set Sequence Number, PDU Set Size in bytes, PDU SN within a PDU Set, Indication of End PDU of the PDU Set, PDU Set Importance (PSI), End of Data Burst indication in the header of the last PDU of the Data Burst.

In various implementations, PDU Set Sequence Number, PDU Set Size in bytes, PDU SN within a PDU Set, Indication of End PDU of the PDU Set, PDU Set Importance (PSI), End of Data Burst indication in the header of the last PDU of the Data Burst may have similar meanings and may be implemented similarly as any of other embodiments/implementations described in the present disclosure.

In various implementations, PDU Set Sequence Number, PDU Set Size in bytes, PDU SN within a PDU Set, Indication of End PDU of the PDU Set, PDU Set Importance (PSI), End of Data Burst indication in the header of the last PDU of the Data Burst may have similar meanings and may be implemented similarly as any of other embodiments/implementations described in the present disclosure.

In some implementations, the PDU Set Sequence Number, PDU Set Size in bytes, PDU SN within a PDU Set, Indication of End PDU of the PDU Set, PDU Set Importance (PSI) are PDU set information and identification which is to identify whether PDUs are in the same PDU set. In some implementations, the service characteristics information existence flag indicates the presence of service characteristics information.

For step 602: the node 2 receives the above information, and therefore can be aware of which PDCP PDUs contained in the NR-U PDU belongs are in the same PDU set and the importance level of each PDU set. When the network is congested, one or all the NR PDCP PDU(s) in the same PDU set with low importance may be discarded. Thus the PDU set information and identification may be used to decide the PDUs needs to be discarded.

When there is integrated handling requirement for a PDU set, and when one or some of NR PDCP PDU(s) in the PDU set is not successfully delivered to the UE, all the other NR PDCP PDUs belongs to the same PDU set may be discarded. The PDU set information and identification may also be used to decide the NR PDCP PDUs needs to be discarded for this case.

In some implementations, the node 2 may make decisions which NR PDCP PDUs need to be discarded based on the above information. After discarding the NR PDCP PDUS, the node 2 may notify the node 1 which NR PDCP PDUs have been discarded via UL GTP-U feedback, e.g. a user plane frame. In some implementations, the UL GTP-U feedback may be DL DATA DELIVERY STATUS frame. The DL DATA DELIVERY STATUS frame format may use the format as describes in any embodiments in the present disclosure, for example, the embodiment set VII and VIII.

In some implementations, the node 1 may be a gNB1, and node 2 may be a gNB2. In some implementations, the node 1 may be a CU, and the node 2 may be a DU.

### Embodiment set VII

TABLE 6
frame includes DL Discarded block information flag and DL Discarded NR PDCP
PDU SN flag

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=1) | | | | Highest | Highest | Final | Lost | 1 |
| | | | | Transmitted | Delivered | Frame | Packet | |
| | | | | NR PDCP | NR PDCP | Ind. | Report | |
| | | | | SN Ind | SN Ind | | | |
| Spare | DL | DL | Delivered | Data | Retransmitted | Delivered | Cause | 1 |
| | Discarded | Discarded | NR | rate | NR PDCP | Retransmitted | Report | |
| | block | NR PDCP | PDCP | Ind. | SN Ind | NR PDCP | | |
| | information | PDU SN | SN | | | SN Ind | | |
| | flag | flag | Range | | | | | |
| | | | Ind | | | | | |

| | |
|---|---|
| Desired buffer size for the data radio bearer | 4 |
| Desired Data Rate | 0 or 4 |
| Number of lost NR-U Sequence Number ranges reported | 0 or 1 |
| Start of lost NR-U Sequence Number range | 0 or (6* |
| End of lost NR-U Sequence Number range | Number of |
| | reported lost |
| | NR-U SN |
| | ranges) |
| Highest successfully delivered NR PDCP Sequence Number | 0 or 3 |
| Highest transmitted NR PDCP Sequence Number | 0 or 3 |
| Cause Value | 0 or 1 |
| Successfully delivered retransmitted NR PDCP Sequence Number | 0 or 3 |
| Retransmitted NR PDCP Sequence Number | 0 or 3 |
| Number of successfully delivered out of sequence PDCP Sequence | 0 or 1 |
| Number range | |
| Start of successfully delivered out of sequence PDCP Sequence Number | 0 or (6* |
| range | Number of |
| End of successfully delivered out of sequence PDCP Sequence Number | successfully |
| range | delivered out |
| | of sequence |
| | PDCP |
| | Sequence |
| | Number range) |
| DL discarded NR PDCP PDU SN | 0 or 3 |
| DL discarded Number of blocks | 0 or 1 |
| DL discarded NR PDCP PDU SN start (first block) | 0 or 3 |
| Discarded Block size (first block) | 0 or 1 |
| . . . | 0 or 1 |
| DL discarded NR PDCP PDU SN start (last block) | 0 or 3 |
| Discarded Block size (last block) | 0 or 1 |
| Padding | 0-3 |

For a non-limiting example, referring to Table 6, a DL Discarded NR PDCP PDU SN flag indicates the presence of DL Discarded NR PDCP PDU SN. In some implementations, the field length may include 1 bit, which is a non-limiting example, and may include other field length values depending on a final design, wherein a value of 1 may be used to indicate that DL Discarded NR PDCP PDU SN is present, and a value of 0 may be used to indicate that DL Discarded NR PDCP PDU SN is not present.

In some implementations, the DL Discarded block information flag indicates the presence of DL discarded number of blocks, DL discarded NR DCP PDU SN start and discarded Block size. In some implementations, its field length may include 1 bit, which is a non-limiting example, and may include other field length values depending on a final design, wherein a value of 1 may be used to indicate that DL discarded number of blocks, DL discarded NR DCP PDU SN start and discarded Block size are present, and a value of 0 may be used to indicate that DL discarded number of blocks, DL discarded NR DCP PDU SN start and discarded Block size are not present.

In some implementations, the DL discarded NR PDCP PDU SN indicates the discarded NR PDCP PDU sequence number up to and including which all the NR PDCP PDUs have been discarded. In some implementations, its field length may include 3 octets/bytes, which is a non-limiting example, and may include other field length values depending on a final design. The discarded NR PDCP PDUs may be indicated as a first range of from 0 to the sequence number, or a second range of from 1 to the sequence number, or a third range of from 0 to (the sequence number −1).

In some implementations, the DL discarded Number of blocks indicates the number of PDCP PDU blocks have been discarded. In some implementations, its field length may include 1 octet/byte, which is a non-limiting example, and may include other field length values depending on a final design.

In some implementations, the discarded NR PDCP PDU SN start indicates the starting SN of a PDCP PDU block which has been discarded. In some implementations, its field length may include 3 octets/bytes, which is a non-limiting example, and may include other field length values depending on a final design.

In some implementations, the discarded Block size indicates the number of NR PDCP PDUs counted from the starting SN to be discarded. In some implementations, its field length may include 1 octet/byte, which is a non-limiting example, and may include other field length values depending on a final design.

### Embodiment set VIII

TABLE 7
frame includes DL Discarded PDU set block information flag and DL Discarded
PDU set SN flag

| | | | | | | | | Number |
|---|---|---|---|---|---|---|---|---|
| Bits | | | | | | | | of |
| 7 | 6 | 5 | 4 | 3 | 2 | 1 | 0 | Octets |
| PDU Type (=1) | | | | Highest | Highest | Final | Lost | 1 |
| | | | | Transmitted | Delivered | Frame | Packet | |
| | | | | NR PDCP | NR PDCP | Ind. | Report | |
| | | | | SN Ind | SN Ind | | | |
| Spare | DL | DL | Delivered | Data | Retransmitted | Delivered | Cause | 1 |
| | Discarded | Discarded | NR | rate | NR | Retransmitted | Report | |
| | PDU | PDU | PDCP | Ind. | PDCP | NR PDCP | | |
| | set | set SN | SN | | SN Ind | SN Ind | | |
| | block | flag | Range | | | | | |
| | information | | Ind | | | | | |
| | flag | | | | | | | |

| | |
|---|---|
| Desired buffer size for the data radio bearer | 4 |
| Desired Data Rate | 0 or 4 |
| Number of lost NR-U Sequence Number ranges reported | 0 or 1 |
| Start of lost NR-U Sequence Number range | 0 or (6* |
| End of lost NR-U Sequence Number range | Number of |
| | reported lost |
| | NR-U SN |
| | ranges) |
| Highest successfully delivered NR PDCP Sequence Number | 0 or 3 |
| Highest transmitted NR PDCP Sequence Number | 0 or 3 |
| Cause Value | 0 or 1 |
| Successfully delivered retransmitted NR PDCP Sequence Number | 0 or 3 |
| Retransmitted NR PDCP Sequence Number | 0 or 3 |
| Number of successfully delivered out of sequence PDCP Sequence | 0 or 1 |
| Number range | |
| Start of successfully delivered out of sequence PDCP Sequence Number | 0 or (6* |
| range | Number of |
| End of successfully delivered out of sequence PDCP Sequence Number | successfully |
| range | delivered out |
| | of sequence |
| | PDCP |
| | Sequence |
| | Number range) |
| DL discarded PDU set SN | 0 or 1 |
| DL discarded Number of PDU set blocks | 0 or 1 |
| DL discarded PDU set SN start (first block) | 0 or 1 |
| Discarded PDU set Block size (first block) | 0 or 1 |
| . . . | 0 or 1 |
| DL discarded PDU set SN start (last block) | 0 or 1 |
| Discarded PDU set Block size (last block) | 0 or 1 |
| Padding | 0-3 |

For a non-limiting example, referring to Table 7, a DL discarded PDU set SN flag indicates the presence of DL discarded PDU set SN. In some implementations, its field length may include 1 bit, which is a non-limiting example, and may include other field length values depending on a final design, wherein a value of 1 may be used to indicate that DL discarded PDU set SN is present, and a value of 0 may be used to indicate that DL discarded PDU set SN is not present.

In some implementations, the DL discarded PDU set block information flag indicates the presence of DL discarded Number of PDU set blocks, DL discarded PDU set SN start and Discarded PDU set Block size. In some implementations, its field length may include 1 bit, which is a non-limiting example, and may include other field length values depending on a final design, wherein a value of 1 may be used to indicate that DL discarded Number of PDU set blocks, DL discarded PDU set SN start and Discarded PDU set Block size are present, and a value of 0 may be used to indicate that DL discarded Number of PDU set blocks, DL discarded PDU set SN start and Discarded PDU set Block size are not present

In some implementations, the DL discarded PDU set SN indicates the discarded PDU set sequence number up to and including which all the PDU sets have been discarded. In some implementations, its field length may include 1 octets/bytes, which is a non-limiting example, and may include other field length values depending on a final design.

In some implementations, the DL discarded Number of PDU set blocks indicates the number of PDU set blocks have been discarded. In some implementations, its field length may include 1 octet/byte, which is a non-limiting example, and may include other field length values depending on a final design.

In some implementations, the DL discarded PDU set SN start indicates the starting SN of a PDU set block which has been discarded. In some implementations, its field length may include 1 octets/bytes, which is a non-limiting example, and may include other field length values depending on a final design.

In some implementations, the Discarded Block size indicates the number of PDU sets counted from the starting SN to be discarded. In some implementations, its field length may include 1 octet/byte, which is a non-limiting example, and may include other field length values depending on a final design.

The present disclosure describes methods, apparatus, and computer-readable medium for wireless communication. The present disclosure addressed the issues with delivering service characteristics information. The methods, devices, and computer-readable medium described in the present disclosure may facilitate the performance of wireless communication by delivering QoS flow information, thus improving efficiency and overall performance. The methods, devices, and computer-readable medium described in the present disclosure may improve the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
sending, by a first network node, downlink (DL) data to a second network node, the DL data comprising service characteristic information corresponding to a data burst comprising at least one protocol data unit (PDU) set.

2. (canceled)

3. A method for wireless communication, comprising:
receiving, by a second network node, downlink (DL) data from a first network node, the DL data comprising service characteristic information corresponding to a data burst comprising at least one protocol data unit (PDU) set.

4-7. (canceled)

8. The method according to claim 1, wherein:
the DL data comprises a service characteristic information flag indicating whether the DL data comprises the service characteristic information; and
in response to the service characteristic information flag indicating that the DL data comprises the service characteristic information, the service characteristic information comprises at least one of the following: a PDU set size, or an indicator indicating to be an end PDU of the data burst.

9-18. (canceled)

19. The method according to claim 1, wherein:
the DL data comprises a service characteristic information flag indicating whether the DL data comprises the service characteristic information.

20. The method according to claim 3, wherein:
the DL data comprises a service characteristic information flag indicating whether the DL data comprises the service characteristic information; and
in response to the service characteristic information flag indicating that the DL data comprises the service characteristic information, the service characteristic information comprises at least one of the following: a PDU set size, or an indicator indicating to be an end PDU of the data burst.

21. The method according to claim 3, wherein:
the DL data comprises a service characteristic information flag indicating whether the DL data comprises the service characteristic information.

22. An apparatus comprising:
a memory storing instructions; and
at least one processor in communication with the memory, wherein, when the at least one processor executes the instructions, the at least one processor is configured to cause the apparatus to perform:
sending downlink (DL) data to a network node, the DL data comprising service characteristic information corresponding to a data burst comprising at least one protocol data unit (PDU) set.

23. The apparatus according to claim 22, wherein:
the DL data comprises a service characteristic information flag indicating whether the DL data comprises the service characteristic information; and
in response to the service characteristic information flag indicating that the DL data comprises the service characteristic information, the service characteristic information comprises at least one of the following: a PDU set size, or an indicator indicating to be an end PDU of the data burst.

24. The apparatus according to claim 22, wherein:
the DL data comprises a service characteristic information flag indicating whether the DL data comprises the service characteristic information.

25. An apparatus comprising:
a memory storing instructions; and
at least one processor in communication with the memory, wherein, when the at least one processor executes the instructions, the at least one processor is configured to cause the apparatus to perform:
receiving downlink (DL) data from a network node, the DL data comprising service characteristic information corresponding to a data burst comprising at least one protocol data unit (PDU) set.

26. The apparatus according to claim 25, wherein:
the DL data comprises a service characteristic information flag indicating whether the DL data comprises the service characteristic information; and
in response to the service characteristic information flag indicating that the DL data comprises the service characteristic information, the service characteristic information comprises at least one of the following: a PDU set size, or an indicator indicating to be an end PDU of the data burst.

27. The apparatus according to claim 25, wherein:
the DL data comprises a service characteristic information flag indicating whether the DL data comprises the service characteristic information.
